(19) United States
(12) Patent Application Publication
(10) Pub. No.: US 2008/0170664 A1
(43) Pub. Date: Jul. 17, 2008

(54) SYSTEM AND METHOD FOR INTERLEAVED SPIRAL CONE SHAPING COLLIMATION

(76) Inventor: Zwi Heinrich Kalman, Rishon Lezion (IL)

Correspondence Address: EMPK & Shiloh, LLP, 116 JOHN ST,, SUITE 1201, NEW YORK, NY, 10038, US

(21) Appl. No.: 12/022,242

(22) Filed: Jan. 30, 2008

Related U.S. Application Data
(63) Continuation-in-part of application No. 11/667,225.
(60) Provisional application No. 60/625,568, filed on Nov. 8, 2004.

(51) Int. Cl. G01N 23/20; G21K 1/04

(52) U.S. Cl. 378/71; 378/153

(57) ABSTRACT

The present disclosure relates to a system and method for an interleaved spiral cone shaping collimation. The present disclosure also relates to an instrumentation that utilizes the interleaved spiral cone shaping X-ray collimator for the identification of concealed materials, or substances, such as explosives and drugs, as well as for the identification of material embedded in objects, even under conditions where invasive examination of said material is impossible, impractical or undesirable.

### RELATED APPLICATIONS

The present application is a continuation-in-part of U.S. application Ser. No. 11/667,225, which was filed in the U.S. Patent and Trademark Office on May 8, 2007 as a US National Phase of PCT Application No. PCT/IL2005/001163, filed on Nov. 7, 2005, which claims benefit under 35 U.S.C. 119(e) of U.S. Provisional Application 60/625,568 filed Nov. 8, 2004 the disclosures of which are incorporated herein by reference.

### BACKGROUND

Conventional instrumentation for detecting explosives concealed in objects such as a baggage or suitcase, by means of X-ray radiography typically relies on the density of explosives being lying within a well-defined range. Substances in suitcases (or in other objects for that matter) whose density lies in this range are detectable, and their position within the object may be established, either (in smaller objects) by visually examining the radiogram, or (for larger objects) by Computed Tomography (“CT”). Using conventional X-ray radiography and CT provides an inadequate solution to the detection problem of suspicious materials, because the density of many benign substances also lies in this particular range. Therefore, though materials detected by conventional methods can be regarded as suspicious; they may eventually be, and in most cases they do, turn out to be benign materials. Thus an additional, second stage test, for deciding whether the suspicious material is benignant or malignant, has to be performed. The second stage typically involves opening the object that contains the suspicious material and manually inspecting the material, which is time and manpower consuming. A frequently used alternative second stage method involves obtaining the energy dispersive X-ray diffraction pattern of the suspicious material. The measured pattern is mathematically normalized to standard conditions and, if sufficiently well resolved, is compared to standard pattern data of target substances. Standard pattern data of target substances have been published, e.g. by the Joint Committee for Powder Diffraction Standards (“JCPDS”).

The unambiguous identification of substances by means of the energy-dispersive diffraction pattern poses, however, several problems, primarily because of the low resolving power used by the method in this application. In part, this is due to the inherent limited resolving power of the energy-dispersive detector and partly in consequence of the unfavorable geometry employed (small diffraction angle). An additional drawback of the method is the necessity to correct the diffraction pattern for absorption along the beam path, which affects differently each pattern segment and requires an additional measurement (of the directly transmitted beam) for mathematically normalizing the measured pattern. The uncertainty, which results from the mathematical combination of the results of two different “noisy” measurements, typically increases compared to the uncertainty resulting from a single measurement.

The favored laboratory method of obtaining the X-ray diffraction pattern for the purpose of identifying, or otherwise characterizing, substances is by means of the angular dispersive method, often referred to as the Debye Scherrer powder method, or X-ray powder diffraction method, whereby a substance is irradiated with an essentially monochromatic and nearly parallel beam, the primary beam, of X-rays, and the intensity of the radiation scattered both coherently (diffracted) as well as incoherently by the substance is measured versus the scatter angle. This diffraction pattern, consisting of a number of intensity peaks of varying magnitude and width, possibly including some partially overlapping peaks, is superimposed on omnipresent scattered background radiation. The pattern is mathematically standardized and, for identification purpose, compared with previously determined pattern; the resolution is usually measured by the width of non-overlapping peaks and determined mainly by the configuration of instrumental components and the intrinsic resolution of the detector.

It is suggested that an alternative method for a second stage identification of a suspicious material be based on obtaining an angular dispersive X-ray pattern of the suspicious material in a non-laboratory environment, by means of instrumentation utilizing the method for an interleaved spiral cone shaping X-ray collimation.

### SUMMARY

In connection with the present disclosure, the term “collimation” may refer to a process of restricting and confining a wave-like radiation, such as, but not limited to, an X-ray beam, to propagate along given ray paths. In one embodiment, a “collimator” may be a device performing collimation.

The present disclosure relates to a system and method for an interleaved spiral cone shaping radiation collimation. The present disclosure also relates to an instrumentation that utilizes the interleaved spiral cone shaping collimator for the identification of substances, including substances embedded in an object. For example, the collimator can be used to identify a very wide range of hidden explosives and drugs via their respective diffraction pattern.

As part of the present disclosure, a collimator is provided, which may be shaped as an interleaved spiral cone frustum forming a spiraling propagation channel through which radiation may propagate. In some embodiments, the collimator may be an X-ray collimator consisting of X-ray absorbing materials.

According to some embodiments, the sheet or sheets may form an interleaved spiral cone frustum

According to some embodiments, the interleaved spiral cone frustum shape may be formed by spiralingly warping a sheet about a warping axis, being substantially the collimator's axis, while a tilt angle existing between a generator line on the sheet and the warping axis varies as a “spiraling”, piecewise continuous function of the angle of rotation about the warping axis.

According to some embodiments, the sheet may be replaced by a number of substantially adjoining sheets, whereby the interleaved spiral cone frustum shape may be formed by spiralingly warping each successive sheet about a warping axis, being substantially the collimator's axis, while a tilt angle existing between a generator line on each sheet and the warping axis varies as a “spiraling”, piecewise continuous function of the angle of rotation about the warping axis.

According to some embodiments the sheet or sheets may be warped in such a way as to preserve a substantially continuous open space between any and every two adjacent loops, thus forming the propagation channel.

According to some embodiments, the sheet(s) may be supportively enclosed in an envelope and, if necessary, provided with additional spikes or supports, for retaining the sheet in its designated place and shape.

According to some embodiments, the envelope may include an inner and an outer cone frustum; the opening angle of the inner cone frustum being equal to twice the minimum tilt angle of the interleaved spiral cone, whereas the opening angle of the outer cone frustum being equal to twice the maximum tilt angle (“Inner” and “outer”—relative to the warped sheet).

According to some embodiments, the inner envelope cone frustum may have top and bottom radiation absorbing plates, or masks, each mask having a pinhole, or bore, through which a primary beam may enter and exit the collimator. A straight line may pass through the two pinholes, which line may substantially coincide with the warping axis.

According to some embodiments, the pinholes may facilitate alignment of the collimator relative to the primary beam, and it may also be utilized for monitoring the primary beam during operation, while a substance is being examined.

As part of the present disclosure, a system for identifying a substance by exposing it to a substantially parallel ray of essentially monochromatic radiation is provided. According to some embodiments, the system may include a source of radiation, for example an X-ray tube for emitting the radiation. The system may further include a device for limiting the radiation to a nearly parallel and essentially monochromatic beam, the primary beam, and directing the beam towards the examined substance to cause radiation to be scattered by the substance. The system may further include an X-ray collimator shaped as an interleaved spiral cone frustum. An examined substance may be positioned between the radiation source and the collimator and surrounding the apex (see FIG. 2 (220) below), such that the direction of the primary beam passes through the substance and substantially coincides with the collimator's axis. At least a portion of the radiation scattered by the substance may enter the propagation channel of the collimator. The system may further include an array of position sensitive detectors for detecting the radiation passing through the propagation channel. The array may be perpendicular to the collimator's axis.

According to some embodiments, the system may further include a monitor unit for monitoring the primary beam passing through the distal pinhole.

According to some embodiments, the system may further include an interpreter for interpreting the detected radiation to identify or otherwise characterize the material. According to some embodiments, the system may further include a storing and/or visualization device, such as, but not limited to, a computer or computer screen, for storing and/or visualizing the pattern generated by the radiation passing through the collimator.

As part of the present disclosure, a method of obtaining an angular dispersive X-ray diffraction pattern from a substance, free standing or embedded in an object, is provided. The method may include irradiating the substance with essentially monochromatic and parallel X-radiation, to scatter radiation therefrom, and detecting the scattered radiation which passes through an X-ray collimator shaped as an interleaved spiral cone frustum.

According to some embodiments, the method may further include interpreting the detected angular dispersive diffraction pattern to identify the irradiated substance, and/or visualizing the detected diffraction pattern.

### BRIEF DESCRIPTION OF THE DRAWINGS

FIG. 1 shows the geometric formation of an interleaved spiral shape cone according to some embodiments of the present invention;

FIG. 2 shows a system for inspecting substances according to some embodiments of the present invention; and

FIG. 3 is a three dimensional general view of a collimator according to some embodiments of the present invention.

It will be appreciated that for simplicity and clarity of illustration, elements shown in the figure have not necessarily been drawn to scale. For example, the dimensions of some of the elements may be exaggerated relative to other elements for clarity. Further, where considered appropriate, reference numerals may be repeated amongst the drawings to indicate corresponding or analogous elements throughout the serial views.

### DETAILED DESCRIPTION

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanying drawings.

In the following description, various aspects of the disclosure will be described. For the purpose of explanation, specific configurations and details are set forth in order to provide a thorough understanding of the disclosure. However, it will also be apparent to one skilled in the art that the disclosure may be practiced without specific details being presented herein. Furthermore, well-known features may be omitted or simplified in order not to obscure the disclosure.

In accordance with some embodiments, the system may shape the ray paths of radiation emitted from a localized source to fit the shape of the channel, or part of the channel, of an interleaved spiral cone frustum (see definitions A to H). An exemplary design of a system and method for an interleaved spiral cone shaping X-ray collimation is described herein below. The resolving power, as measured by the full width at half maximum (“FWHM”) of non-overlapping reflections peaks, may depend on the geometry employed.

According to some embodiments, instrumentation based on the method for an interleaved spiral cone shaping X-ray collimation, may be utilized to measure scatter-angle dependency of the intensity of radiation scattered from a spatially defined source embedded in an object, without experiencing interference from radiation that may be scattered or otherwise emanate from regions outside the source. According to some embodiments, the volume containing the source may be referred to as the “volume of interest”. The pattern so measured may be the angular dispersive diffraction pattern of the substance contained in the volume of interest, thereby facilitating the non-invasive identification of the substance.

According to some embodiments, the collimator or collimation system may be utilized for medical diagnostics. According to further embodiments, the principal condition for the medical (or any other) application is that, in view of absorption effects, the radiation at the wavelength producing the diffraction pattern be intense enough to generate an acceptable diffraction pattern. In an embodiment, the longest wavelength (λ) that still fulfills the latter condition may be used and the geometry of the collimator may be constructed for that wavelength.

In one embodiment, the system and method for an interleaved spiral cone shaping X-ray collimation may be based on a geometrical concept, to be called an “interleaved spiral cone”, which may be, according to some embodiments of the invention, a two dimensional surface that is spatially and spirally warped, according to certain embodiments, as follows:

### Definition of the Interleaved Spiral Cone (Definition A), According to Certain Embodiments:

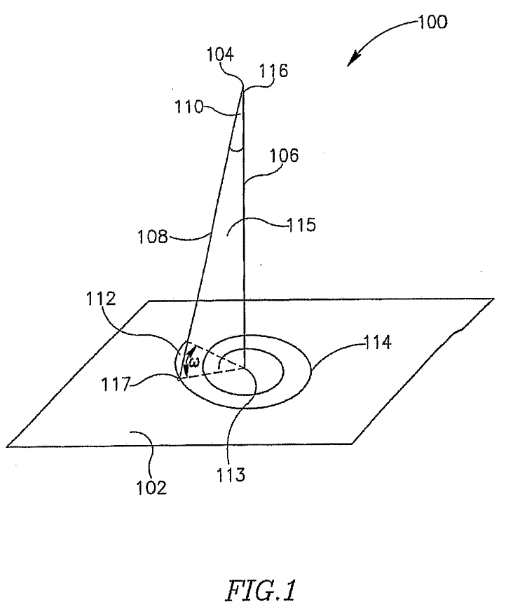

Referring now to FIG. 1, it shows the geometric formation of an interleaved spiral shape cone according to some embodiments of the present invention. The interleaved spiral cone formation (100) may be schematically described according to some embodiments of the invention, as follows: let Π denote a plane (102), shown in horizontal position for convenience, and let A, to be called the apex (104) of the interleaved spiral cone, be a point whose vertical distance (106) from plane 102 (Π) is Lo. Plane (102) may be regarded as a “projection plane”, as an (explicit or implicit) image of a diffraction pattern may be output by the collimator at this plane, to be projected onto an image detector. The normal line from apex A (106) onto Π (102) will be called the (longitudinal) “warping axis” of the interleaved spiral cone (hereinafter “axis”, or, sometimes, “collimator's axis” or interleaved spiral cone's axis). The intersection of axis (106) with plane (102) will be referred to as “base origin”, denoted by ‘O’ (113). The generator line, ‘G’ (108), of the interleaved spiral cone is a straight line whose upper, proximal, end (116) coincides with the apex A (104) and its lower, distal, end (117) “touches” plane 102 for every position of the generator line 108. The angle (γ) between the generator line G (108) and the axis (106) will be called the “tilt angle” (110). By definition, γ is always greater than zero. The interleaved spiral cone is the plane “swept out” by generator line (108) as generator line (108) rotates, without changing sense, about warping axis (106), whilst the tilt angle (γ) (110) varies as a “spiraling”, piecewise continuous function, as defined by equations eq. 1a. and eq. 1b, of the angle of rotation ω (112). A piecewise continuous function is a continuous function that may include a finite number of jump-discontinuities.

The angle of rotation ω (112) is the angle formed between the projection of generator line G onto plane (102) and an arbitrary initial line emanating from base origin O. Trace (117) is an exemplary trace made by moving the distal point (117) of generator line (108) on plane (102) while generator line (108) rotates about axis (106). The sense of rotation will be defined as ‘positive’, for calculation purpose. An interleaved spiral cone may be characterized by the functional dependence of the tilt angle γ (110) on ω (112) over a finite rotational displacement of generator line G (108).

γ(ω)=γₒ+F(ω) (eq. 1a)

where ‘γₒ’ is some positive constant and F(ω) is any piecewise continuous function of ω (112).

The “spiraling” property of F(ω) is expressed for an essentially increasing function by the condition:

F(ω)<F(ω+2π) (eq. 1b)

For an essentially decreasing function, the inequality sign in eq. 1b is to be inverted.

The interval corresponding to a rotational angle variation of 2π is herein referred to as a “complete loop”.

For illustration purpose, three typical, cases are described hereinafter:

Case (a): The tilt angle γ (110) increases linearly with ω (112):

γ(ω)=γₒ+(ω×dγ) (eq. 2a)

where ω varies over the interval from ωₐ to ω_{b}, where

ωb≧ω≧ωa;dγ>0;γₒ>0 (eq. 2b)

In this case, the interleaved spiral cone “loops” about the axis 106, and the pitch of the tilt angle Γ is:

Γ=2π×dγ. (eq. 2c)

The azimuth angle θ is related to the rotation angle ω by:

θ=mod(ω,2π)* (eq. 2δ)

* The function mod(x,y) denotes the reminder of the division x/y.
The tilt angle (eq. 2a) may be expressed in terms of the azimuth angle and the number N of completed loops:

γ(θ,N)=(N×Γ)+(θ×dγ) (eq. 2e)

Case (b): The tangent of the tilt angle increases linearly with ω. By substituting tan(γ) and d(tan(γ)) for γ and dγ respectively, equations eq. 2a to 2e are valid also for this case. For tilt angles smaller than 15 degrees case(a) and case(b) are practically identical.

Case (c): The tilt angle γ (110) is constant for an interval of constant length ωo (112) ωo<2π and changes abruptly every ωo radians by an amount dΓ:

γ(ω)=γₒ+{mod(ω,ωo)×dΓ}* (eq. 3a)

* The function mod(x,y) denotes the reminder of the division x/y.
As in case (a), ω varies over the interval from ωₐ to ω_{b}, with

ω_{b}≧ω≧ωₐ;dΓ>0;γₒ>0 (eq. 3b)

The interval ωₒ may be written as:

ωₒ=2π/m (eq. 3c)

where ‘m’ may be an integer, though this is not necessarily so. For integer ‘m’, the tilt angle increases with every completed loop by the amount Γ:

Γ=m×dΓ (eq. 3d)

It is noted that case (a) is the limit of case (c) as the value of ‘m’ may increase to infinity.

### Definition of Interleaved Spiral Cone Base (Definition B), According to Some Embodiments:

Let γₘₓ be the largest tilt angle 110 of an interleaved spiral cone and let Lo (106) be the vertical distance from its apex (104) to plane 102. The circular disk on plane 102 whose center lies at O (see definition A) and radius ‘R’ is given by equation eq. 4a,

R=Lo×tan(γₘₓ) (eq. 4a)

is called the base of the interleaved spiral cone.

### Definition of Interleaved Spiral Cone Clearance, (Definition C), According to Some Embodiments:

Let Πi be a horizontal plane between apex 104 and base 102 at height ‘Li’ from the base 102. Let the intersection of the interleaved spiral cone axis 106 with Πi be the origin of a polar coordinate system {θ, r}. The intersection between the spiral cone and Hi is a curve described by eq. 4:

r(θ,N)=(Lo−Li)×tan(γ(θ,N)) (eq. 4b)

where ‘θ’ is identical to the corresponding azimuth angle θ, ‘N’ is the number of completed loops (about axis 106) and ‘γ(θ,N)’ is the tilt angle. (see, for example, eq. 2e).

The radius vector ‘r’ is a multi-valued function of θ. The distance, or spacing, between any two adjacent radius vectors r(θ,N) and r(θ,N+1) corresponding to the same angle θ will be called the “clearance” of the interleaved spiral cone on Πi at position r(θ,N) and θ.

### Definition of Interleaved Spiral Cone Loop (Definition D), According to Some Embodiments:

An interleaved spiral cone loop is defined as the surface swept out by the generator line as it rotates about the warping axis to complete an angle of 2π radians.

### Definition of Interleaved Spiral Cone Propagation Channel, (Definition E), According to Some Embodiments:

The interleaved spiral cone propagation channel is defined as the region “bordered” by, or confined between, two curved surfaces relating to two adjacent loops of the interleaved spiral cone. The intersection between the propagation channel borders with plane Πi, (see definition C) are two curves, parallel to the loops generated by the intersection between the interleaved spiral cone and plane Πi. The radius vectors leading to the two curves r′(θ,N) and r′(θ,N+1), (using the polar coordinate system defined in definition C) are related to the corresponding vectors that lead to the intersection of the interleaved spiral cone according to eq. 5:

r′(θ,N)=r(θ,N)+δr₁; r′(θ,N+1)=r(θ,N+1)−δr₂ (eq. 5)

where δr₁ and δr₂ are positive numbers that may depend on the height Li of plane Πᵢ. δr₁+δr₂ must be less than the clearance r(θ,N+1)−r(θ,N).

### Definition of Interleaved Spiral Cone Frustum, Apex and Axis Thereof, (Definition F), According to Certain Embodiments:

The frustum of the interleaved spiral cone is that part of the interleaved spiral cone bounded by the base and a plane that is parallel to the base and positioned between the base and apex. The apex and axis of an interleaved spiral cone are defined as being also apex and axis, respectively, of any frustum of that interleaved spiral cone.

### Definition of Frustum, Apex and Axis of the Interleaved Spiral Cone Channel, (Definition G), According to Certain Embodiments:

Definitions of frustum, apex and axis of the interleaved spiral cone (definition F) are applicable, mutatis mutandis, to the interleaved spiral cone channel.

### Definition of the Interleaved Spiral Cone Shaping Collimator, (Definition H), According to Certain Embodiments:

The defining property of the interleaved spiral cone shaping collimator is the capability of shaping the ray path of radiation, scattered from a localized region within an extended object so as to cause the ray to proceed essentially along the channel, and only along that channel, of an interleaved spiral cone frustum (definition F). Any design having this capability may be regarded as an “interleaved spiral cone shaping collimator”.

The term “essentially”, according to embodiments of the invention, refers to the ray paths that are shaped by the ray-shaping elements, disregarding the effects on the radiation of construction parts required to support the ray-shaping elements or fulfill other constructional requirements.

As part of the present invention, the description of an interleaved spiral cone collimator, henceforth to be called “collimator” for short, is provided. According to some embodiments of the invention, the collimator may consist of a single sheet or a combination of adjoining sheet sections, made of X-ray absorbing materials (see definition I) shaped, or spirally warped, so that the sheet's center plane or the combination of the center planes of the sheets form the frustum of an interleaved spiral cone. Said frustum will be referred to as the “guiding frustum”. According to some embodiments the sheet or sheets may be warped in such a way as to preserve a substantially continuous open space between any and every two adjacent loops. Bottom and top ends of the collimator may coincide with the base and top ends of the guiding frustum. The apex and axis of the collimator are apex and axis, respectively, of the guiding frustum. According to some embodiments, the warped sheet or sheets are supportively enclosed in an envelope, which may also include construction elements required for firmly supporting and retaining the sheet(s) in its designated place and shape.

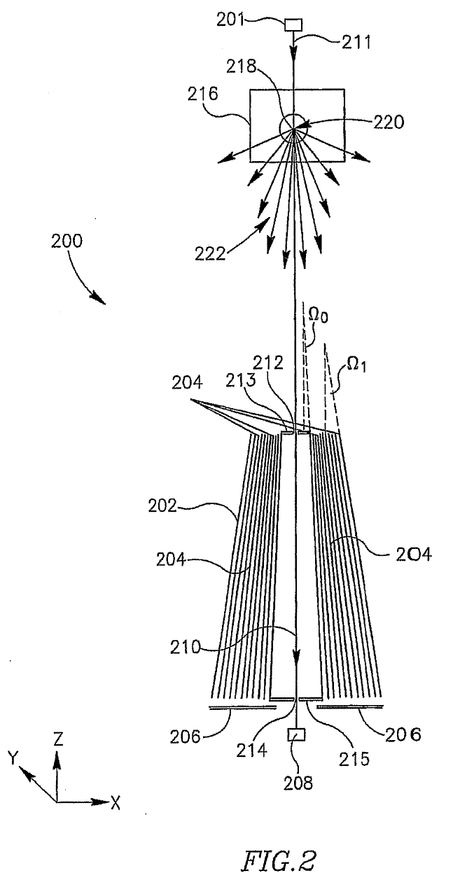

According to some embodiments, the spiraling sheet(s) of the collimator may be enveloped by two cone frustums, an inner one and an outer one, arranged in concentric manner. Put otherwise, the inner cone frustum may concentrically reside within the outer cone frustum, their apexes “pointing” to the same direction, in a way that the spiral cone collimator may reside in between. According to some embodiments, the opening angle Ω₀ (FIG. 2) of the inner cone frustum may be as twice the minimum tilt angle [(110), FIG. 1] of the interleaved spiral cone, whereas the opening angle Ω₁ (FIG. 2) of the external one may be twice the maximum tilt angle (110) of the interleaved spiral cone. Top and bottom of the collimator are open. Top and bottom of the inner cone frustum may each be provided with a mask having a centralized pinhole, or bore, to facilitate alignment of the collimator with the primary beam and monitoring of the primary beam during operation. The straight line between the two pinholes may coincide with the collimator's longitudinal axis.

The open space between any two adjacent loops of the interleaved spiral-cone shaped sheet, which is part of the propagation channel, may guide the passage of X-rays. This is the “ray-shaping channel” (see definition E). (204) The channel widens from top, which is the side closest to the radiation source, to bottom. Possible constructing elements located in the channel should be kept as non-obstructive as possible to the X-ray passage.

As part of the present invention, a system using the collimator is also provided. According to some embodiments of the invention, the system may include the collimator; a planar position sensitive recording device, such as, for example, a planar array of X-ray sensitive pixels of sufficient resolution, a photographic plate and the like. The planar position sensitive recording device may be placed at the collimator base and perpendicular to the collimator's longitudinal axis. The diffraction pattern may be recorded on the recording device as nearly complete Debye-Scherrer rings (a small part of each ring may be obscured by the shadow of part of the sheet serving as partition). According to some embodiments, a photographic plate may be used as a recording device for recording the resulting pattern and, after developing, for visualizing the recorded pattern.

According to some embodiments, the recording device may be a planar array of X-ray sensitive pixels. The center of pattern is the point on the array coinciding with the base origin O defined in definition A. All pixels lying within a circular sector of P degrees (P=360/N, N a small integer) may be interconnected and connected to the same channel of a multichannel read-out instrument Moreover some circular sectors having adjacent radii may be interconnected so that each sector accepts radiation from a different range of scatter angles. The details of the connection scheme depend mainly on pixel size and collimator channel width.

The recording device may be positioned and shielded so that all X-rays propagating through the collimator, and only those rays, may reach the recording device.

### Definition of X-Ray Absorbing Material (Definition I), According to Certain Embodiments:

Materials or sheets of such thickness that at least 99.99% of the radiation intensity of any ray at the wavelength generating the diffraction pattern, that passes through the collimator from top to base whilst traversing at least once a sheet made of X-ray absorbing material, is absorbed by that sheet. In addition, the radiation intensity of any ray whose wavelength is registered by the detector, should, on passing the collimator from top to bottom and traversing the sheet at least once, constitute not more than a few percent of the general background radiation.

According to one embodiment, the primary beam may be a nearly parallel beam of X-rays, essentially monochromatic (such as, but not limited to, characteristic, beta-filtered, radiation from a commercially available X-ray tube and a pinhole arrangement defining the primary beam path, as used e.g. in crystal rotating X-ray cameras) and sufficiently intense to produce an interpretable diffraction pattern. According to some embodiments of the invention, the collimator may be positioned so that its axis coincides with the primary beam direction, the collimator's top may be directed towards the X-ray source. In one embodiment of the invention, the space between the exit opening of the primary beam and the top of the collimator, the sample space, may be sufficient to place the object, or examined material, in between. In another embodiment, the distance apex to collimator top may not be less than said sample space. According to some embodiments of the invention, the principal components of the instrument, namely the X-ray tube, primary beam assembly, collimator and detector may be rigidly connected in the direction perpendicular to the primary beam. In another embodiment, the collimator, with the planar detector attached to its base, may be able to undergo controlled movement in the direction of the collimator axis (which is also the direction of the primary beam) for a distance equal at least to the length of the primary beam path within the object.

After detecting the presence and location of a “target” substance in an “object” such as a suitcase, for example by using conventional X-ray radiography or CT, the instrument and/or “object” may be positioned relative to one another such that the primary beam passes through the volume of interest. In another embodiment, the collimator may than be moved along its axis until its apex resides within the volume of interest Hence the distance target to collimator base is Lo (106, FIG. 1).

Referring now to FIG. 2, in accordance with some embodiments, the system (200) for testing a suspicious material, may include an interleaved spiral cone collimator (202) comprised of channel defining sheet or sheets (204), an array of planar position sensitive detectors (206), a direct beam monitor (208) adapted to detect the direct X-ray beam (210) entering upper pinhole (212) located in upper radiation absorbing mask (213) and exiting a lower pinhole (214) located in a lower radiation absorbing mask (215). The nearly parallel primary beam (211) may penetrate through a bag, parcel, suitcase or any other object (216), and through a suspected item (218) to be examined. The position of item (216) may be adjusted along the X- and Y-directions so that primary X-ray beam (211) would pass substantially through the center of the volume of interest (218). Alternatively, or additionally, the position of system (200) may be changed along the Z-direction to position the apex (220) of the interleaved spiral cone collimator (202) substantially within the volume of interest (218). The scattered beams (222) that emanate from the material surrounding the apex (218), and only these rays, pass through the interleaved spiral cone collimator (202), provided the rays are scattered at angles that lie within the angular range from minimum to maximum tilt angle (the acceptance angles) of the collimator. The scatter-angle dependent intensity pattern of the radiation scattered from the material surrounding the apex may be sensed by the planar array of sensitive detectors (206) as this material's angular dispersive diffraction pattern. The direct beam monitor (208) adapted to detect pattern generating (monochromatic) component of the primary X-ray beam (210) may be used for calibrating, and evaluating the performance of, the system. For example, if the X-ray intensity is not strong enough to penetrate the object, or e.g. if the object is enclosed in some heavy X-ray-opaque material, the monitor (208) will show low or no reading.

In some cases (depending on what is to be measured), it might be advantageous to rotate the aligned collimator about its axis during operation. Depending on the aim of the measurement, the detecting array may rotate rigidly connected to the collimator, or stay stationary at the collimator's base whilst the collimator rotates.

The functional characteristics of the collimator may be summarized as follows:

1) Permitting X-radiation scattered from a small volume surrounding the apex, and only radiation scattered from this volume, to reach the detector.
2) From the position of the point of incidence of any ray that reaches the detector, the scatter angle of that ray can be uniquely determined with an accuracy equal to the angular resolution of the instrument.
3) All Debye-Scherrer rings of the diffraction pattern, whose scatter angles fall within the collimator's angular acceptance range, are recorded by the detector.
Depending on the geometry of the ray-guiding sheet, or propagation channel, a small part of each Debye-Scherrer ring may be blocked by a portion(s) of the sheet.

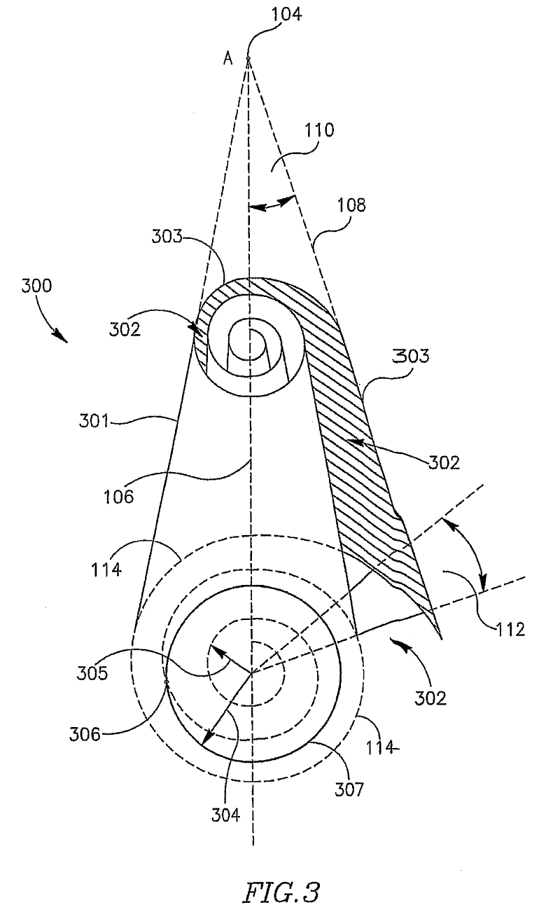

FIG. 3 shows a three dimensional general view of a collimator according to some embodiments. A cross-sectional view of the collimator is shown in FIG. 2 (202). Sheet 303, made of X-ray absorbing material, is spirally warped about warp axis (106), whereby forming a spiral-like channel (302) that “opens” in the direction from apex A (104) downwards, in a general direction along axis (106). Spiral-like channel (302) is the channel through which a portion of radiation scattered from material near apex A propagates, whereas radiation possibly scattered from other regions is absorbed by the X-ray absorbing sheet (303).

Collimator (300) may be utilized for uniquely identifying substantially any polycrystalline material. An amorphous substance or a substance having low crystallinity (such as many biological materials) may present a diffraction pattern that does not permit unique identification, mainly due to paucity of diffraction peaks. However even such a pattern may assist in limiting the number of possible candidate materials for identification.

In one embodiment, the invention provides a device for collimating radiation including an interleaved spiral cone element. In another embodiment, an interleaved spiral cone element may be an element having the shape of an interleaved spiral cone frustum.

In another embodiment, the radiation may be an electromagnetic radiation. In another embodiment, the electromagnetic radiation may be X-ray radiation.

In another embodiment, the interleaved spiral cone element may include a sheet or sheets forming said interleaved spiral cone element. In another embodiment, the sheet or sheets may include a material capable of absorbing said X-ray radiation. In another embodiment, the interleaved spiral cone element may be formed by spirally warping said sheet or sheets about a warping axis, whilst a tilt angle, defined by a generator line on said sheet and said warping axis, is varying as a spiraling, piecewise continuous function of the angle of rotation about said axis. In another embodiment the sheet or sheets may be warped in such a way as to preserve a substantially continuous open space between any and every two adjacent loops.

In another embodiment, the device may further comprise a supporting element adapted for retaining the shape of said interleaved spiral cone element. In another embodiment, the supporting element may be any kind of substance, material, construction element and the like that may assist in maintaining the shape of the interleaved spiral cone without obstructing materially the X-ray transmissibility of the channel. In another embodiment, the supporting element may include a cone frustum. In another embodiment, the supporting element may be in the shape of a cone frustum. In another embodiment, the cone frustum may be mounted on the external surface of said interleaved spiral cone element. In another embodiment, the cone frustum is mounted on the internal surface of said interleaved spiral cone element.

In another embodiment, the device may include an radiation absorbing mask having a pinhole adapted to allow the passage of the primary beam of said radiation, wherein said primary beam substantially coinciding with the warping axis.

In accordance with some embodiments, the invention provides a system for identifying a substance, the system may include a radiation source adapted to irradiate a substance, a device for collimating said radiation, the device may include an interleaved spiral cone element, and a detector adapted to detect the radiation scattered from said substance.

In another embodiment, the radiation may be an electromagnetic radiation. In another embodiment, the electromagnetic radiation may be X-ray radiation.

In another embodiment, the interleaved spiral cone element may be an interleaved spiral cone frustum.

In another embodiment, the radiation source may be adapted to produce a primary radiation beam which substantially passes through, or in close proximity to the axis of said interleaved spiral cone. In another embodiment, the detector may be a position sensitive detector. In another embodiment, the system may further include a monitor adapted to monitor the primary beam.

In another embodiment, the system may further include an interpreting element adapted to identify the substance. In another embodiment, the system may further include an interpreting element adapted to identify the substance using reference data. In another embodiment, the reference data may include diffraction pattern or information related to known materials. In another embodiment, the system may further include a visualization device for visualizing the detected radiation.

In accordance with other embodiments, the invention further provides a method for identifying a substance, the method may include irradiating a substance, detecting the radiation scattered from said substance, wherein said radiation scattered from said substance is allowed to pass through a collimating device comprising an interleaved spiral cone element, prior to detection. In another embodiment, the radiation may be an electromagnetic radiation. In another embodiment, the electromagnetic radiation may be X-ray radiation.

In accordance with other embodiments, the invention further provides a method of obtaining an angular dispersive X-ray diffraction pattern of a substance, the method may include irradiating a substance with X-ray radiation, thereby obtaining radiation scattered from said substance; and obtaining the angular dispersive X-ray diffraction pattern of said substance, after said radiation scattered from said substance passes through a collimating device comprising an interleaved spiral cone element.

In another embodiment, the interleaved spiral cone may be an interleaved spiral cone frustum.

In another embodiment, detecting may include obtaining an angular dispersive X-ray diffraction pattern of a substance. In another embodiment, the method may further include interpreting said angular dispersive X-ray diffraction pattern of said substance, thereby identifying said substance. In another embodiment, the substance may be identified using reference data. In another embodiment, the reference data may include diffraction pattern or information related to known materials. In another embodiment, the method may further include visualizing the detected radiation.

In another embodiment, “substance” as referred to herein may be any material, object, device, item or the like. In another embodiment, “substance” as referred to herein may be a suspicious matter, an explosive material, a potentially explosive material and the like.

In accordance with other embodiments, the invention further provides an array of ray shaping elements, having a radiation entrance and a radiation exit, such that the ray paths of radiation passing through the device are shaped essentially the way ray paths are shaped by the collimator as referred to herein.

Depending on the examined substance, it may occur that the relative intensity along a given diffraction ring will not be constant. That is, the relative intensity of a ring may vary as a function of the location on the ring. It may also occur that some portion of the ring are so shadowed that no data can be collected therefrom. Such a phenomenon may occur, for example, when irradiating a substance having a preferred crystalline orientation, in which case portion(s) of the diffraction ring may have a higher intensity relative to other portion(s) of the diffraction ring. For this reason, and according to some embodiments, the interleaved spiral cone element may be rotated during operation, about its longitudinal (warping) axis, so that data may be collected for essentially the entire diffraction ring.

The foregoing description of the embodiment of the invention has been presented for the purpose of illustration and description. It is not intended to be exhaustive or to limit the invention to the precise form disclosed. It should be appreciated by persons skilled in the art that many modifications, variations, substitutions, changes and equivalents are possible in light of the above teaching. It is, therefore, to be understood that the appended claims are intended to cover all such modifications and changes as fall within the true spirit of the invention.

What we claim is:

1. A device for collimating radiation comprising an interleaved spiral cone element.

2. The device of claim 1, wherein said radiation is X-ray radiation.

3. The device of claim 1, wherein said interleaved spiral cone element is shaped as an interleaved spiral cone frustum.

4. The device of claim 1, wherein said interleaved spiral cone element comprises a sheet or adjoining sheets forming an interleaved spiral cone frustum.

5. The device of claim 4, wherein said sheet comprises a material capable of absorbing said radiation.

6. The device of claim 5 wherein said interleaved spiral cone element is formed by spirally warping said sheet about a spiral warping axis, whilst a tilt angle, defined as the angle between a generator line on said sheet and said warping axis, is varying as a piecewise continuous function of the angle of rotation about said axis.

7. The device of claim 5, wherein a substantially continuous open space exists between two adjacent loops of said sheet or sheets, thus forming the propagation channel for collimating radiation.

8. The device of claim 1, further comprising supporting elements adapted for retaining the shape of said interleaved spiral cone element.

9. The device of claim 8, wherein said supporting elements include two envelopes each shaped as a cone frustum.

10. The device of claim 9, wherein one of said envelopes is mounted on the external surface of said interleaved spiral cone element.

11. The device of claim 9, wherein the second of said envelopes is mounted on the internal surface of said interleaved spiral cone element.

12. The device of claim 11, wherein said envelope further comprising an X-ray absorbing mask on top and on bottom, each having a pinhole adapted to allow the pass of the primary beam of said radiation, wherein said primary beam substantially coinciding with the warping axis.

13. A system for identifying a substance, the system comprising:
a radiation source adapted to irradiate a substance;
a device for collimating said radiation, the device comprising an interleaved spiral cone element; and
a detector adapted to detect the radiation scattered from said substance.

14. The system of claim 13, wherein said radiation is X-ray radiation.

15. The system of claim 13, wherein interleaved spiral cone element is a interleaved spiral cone frustum.

16. The system of claim 13, wherein said radiation source is adapted to produce a primary radiation beam which substantially passes through, or in close proximity to the axis of said interleaved spiral cone.

17. The system of claim 13, wherein said detector is a position sensitive detector.

18. The system of claim 13, further comprising a monitor adapted to monitor the primary beam.

19. The system of claim 13, further comprising an interpreting element adapted to identify the substance.

20. The system of claim 13, further comprising a storing and/or visualization device for storing and/or visualization the detected radiation pattern.

21. A method for identifying a substance, the method comprising:
irradiating a substance;
detecting the radiation scattered from said substance, wherein said radiation scattered from said substance is allowed to pass through a collimating device comprising an interleaved spiral cone element, prior to detection.

22. The method of claim 21, wherein said radiation is X-ray radiation.

23. The method of claim 22, wherein the interleaved spiral cone element is shaped as an interleaved spiral cone frustum.

24. The method of claim 23, wherein detecting comprises obtaining an angular dispersive X-ray diffraction pattern of a substance.

25. The method of claim 24, further comprising interpreting said angular dispersive X-ray diffraction pattern of said substance, thereby identifying said substance.
